(19) United States
(12) Patent Application Publication
(10) Pub. No.: US 2018/0184690 A1
(43) Pub. Date: Jul. 5, 2018

(54) AQUATIC ENRICHMENT FEEDER

(71) Applicant: Robert Andrew Richards, Darien, CT (US)

(72) Inventor: Robert Andrew Richards, Darien, CT (US)

(21) Appl. No.: 15/863,249

(22) Filed: Jan. 5, 2018

Related U.S. Application Data
(60) Provisional application No. 62/442,869, filed on Jan. 5, 2017.

(51) Int. Cl. A23K 50/80; A01K 61/60

(52) U.S. Cl. CPC A23K 50/80; A01K 63/04; A01K 61/60

(57) ABSTRACT

An aquatic feeder. The aquatic feeder includes a first portion connected to a second portion. The first portion is made of a material floatable in water. The second portion includes a sidewall defining an internal cavity. At least one aperture is formed through the sidewall. A divider is disposed in between the first portion 18 and the second portion and acts as a cap for the internal cavity of the second portion. The internal cavity is configured to retain an aquatic animal food. The at least one aperture is configured to release the aquatic animal food when the at least one aperture is submerged in water.

### CROSS-REFERENCE TO RELATED APPLICATION

This application claims the benefit of priority of U.S. provisional application No. 62/442,869, filed Jan. 5, 2017, the contents of which are herein incorporated by reference.

### BACKGROUND OF THE INVENTION

The present invention relates to an aquatic feeder and, more particularly, to an aquatic feeder that stimulates marine animals.

Fishkeeping is a popular hobby, practiced by aquarists, concerned with keeping fish in a home aquarium or a garden pond. Freshwater fishkeeping is by far the most popular branch of the hobby, with even small pet stores often selling a variety of freshwater fish, such as goldfish, guppies and angelfish. Marine aquaria have more specific needs and requirements to maintain, and the livestock is generally more expensive. As a result, this branch tends to attract more experienced fish keepers. Marine aquaria can be exceedingly beautiful, due to the attractive colors and shapes of the corals and the coral reef fish they host.

Currently, captive marine life are fed by placing the fish food into the water of the aquarium or directly into the animal's mouth. The above-mentioned methods of feeding marine life provides no stimulation for the animal. Professional aquariums and fish keepers are constantly looking for new ways to stimulate their animals.

As can be seen, there is a need for a feeding device that simulates marine animals.

### SUMMARY OF THE INVENTION

In one aspect of the present invention, an aquatic feeder comprises: a first portion comprising a material floatable in water; a second portion connected to the first portion, the second portion comprising a second portion sidewall defining an internal cavity and at least one aperture formed through the second portion sidewall; and a divider forming a cap for the internal cavity, wherein the internal cavity is configured to retain an aquatic animal food; and the at least one aperture is configured to allow the aquatic animal food to be releasable when the at least one aperture is submerged in water.

In another aspect of the present invention, a method of feeding aquatic animals comprises: providing an aquatic feeder comprising: a first portion comprising a material floatable in water; a second portion connected to the first portion, the second portion comprising a second portion sidewall defining an internal cavity and at least one aperture formed through the second portion sidewall; and a divider forming a cap for the internal cavity; inserting an aquatic animal food within the internal cavity of the second portion; and placing the aquatic feeder on water within a water tank, wherein the aquatic feeder floats in the water, and the aquatic animal food can escape the internal cavity through the at least one aperture when the at least one aperture is submerged in water.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is a bottom view of an embodiment of the present invention;

FIG. 4 is a top perspective exploded view of an embodiment of the present invention;

FIG. 5 is a bottom perspective exploded view of an embodiment of the present invention; and

FIG. 6 is a section view of the present invention taken along line 6-6 in FIG. 3 shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an aquatic enrichment feeder. The aquatic enrichment feeder turns feeding marine animals into a game. A user may place food inside the device, seal the device closed, and toss the device into the water. The device floats on the surface, and while being partially submerged, the device rotates and exposes feeding holes that provide a mentally stimulating eating challenge for captive marine animals. The present invention provides a behavior enrichment feeding experience for marine life in any aquatic environment. When the device is engaged or played with by the marine animals, water flows through the aperture causing the food inside the cavity to come out thus providing a challenge.

The present invention includes a floating portion connected to a feeding portion. The floating portion serves as a bowl for the food and allows the device to float partially in the water. The floating portion is also designed to help rotate the device so that the feeding portion faces towards the bottom of the water thus exposing the feeding apertures towards the marine animals. This allows the marine animals to access the food stored in the device. The challenge for marine animals is to force the food out of the device by pushing the device through the water. As water flows through the feeder apertures more food is accessible.

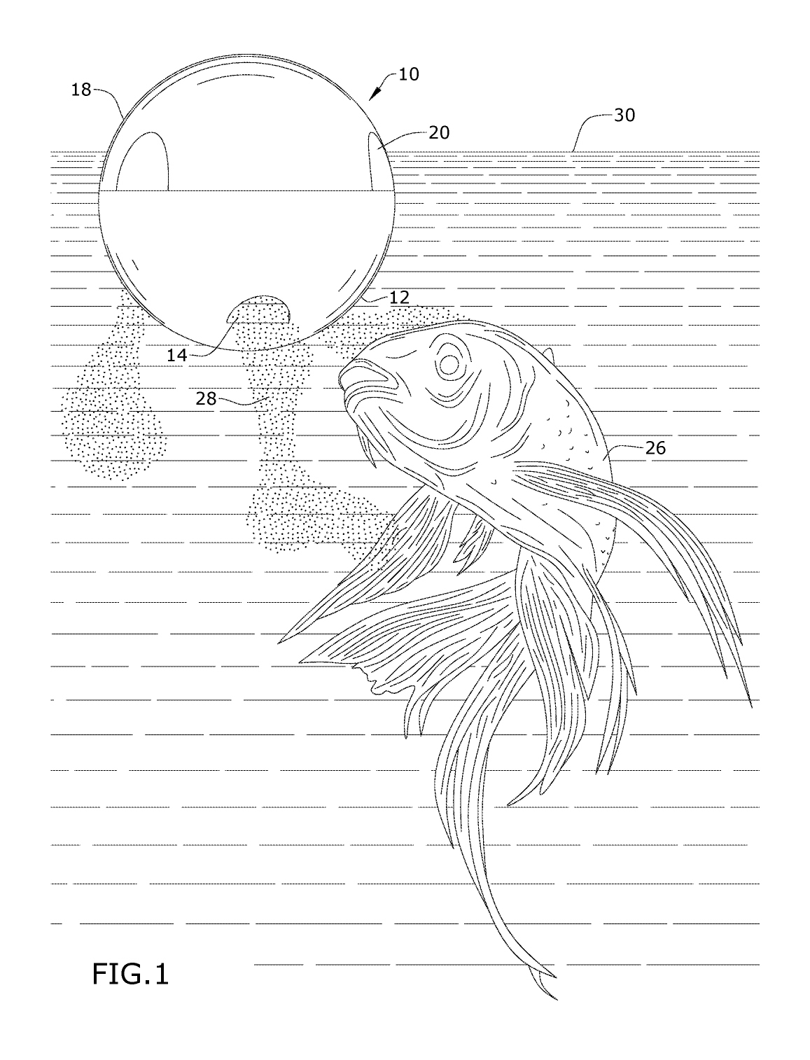

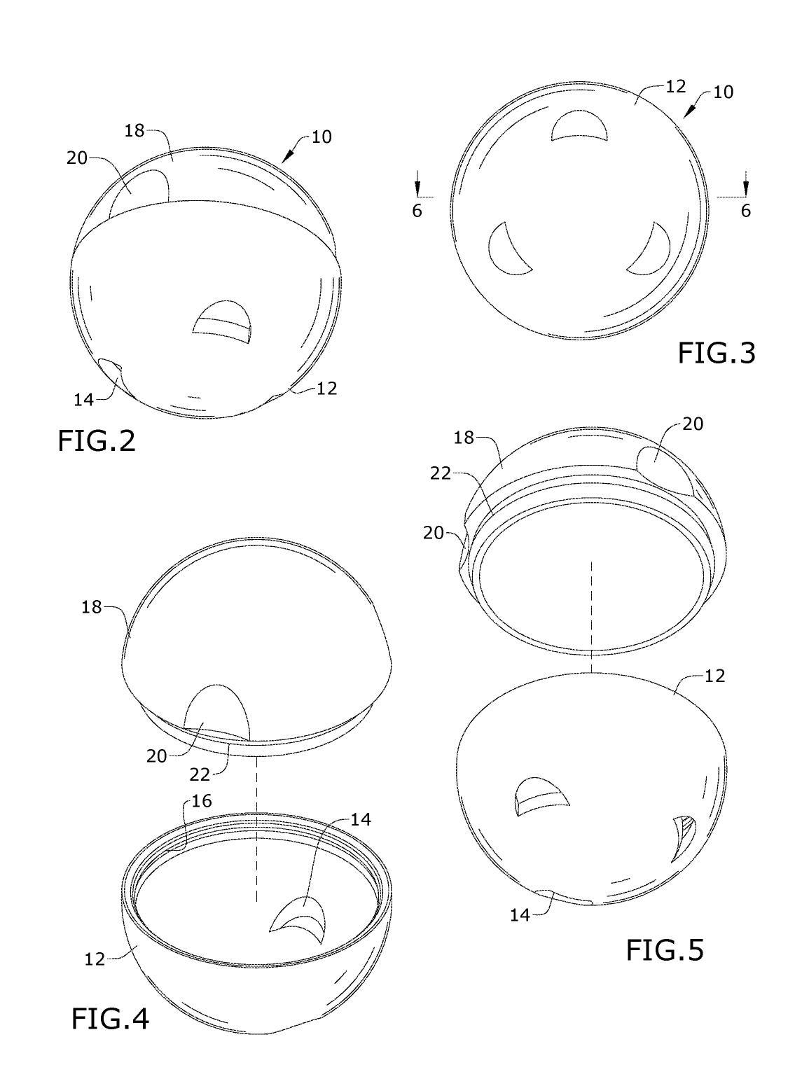

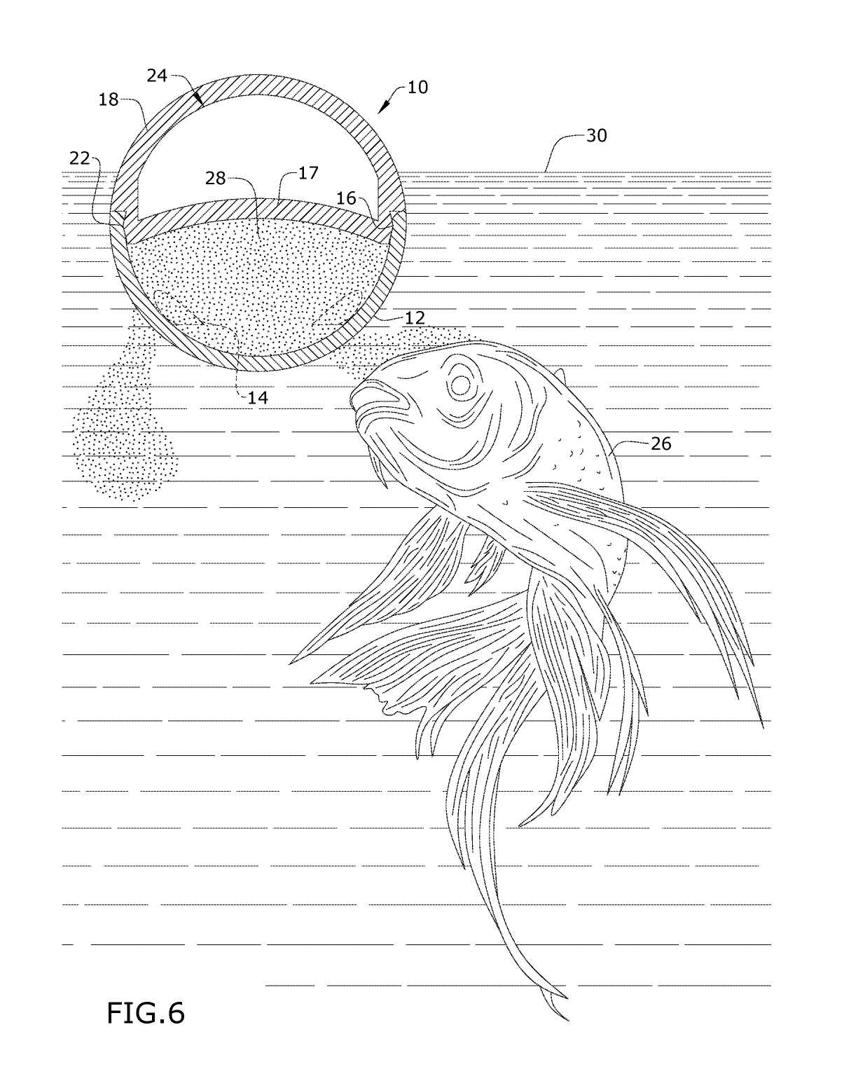

Referring to FIGS. 1 through 6, the present invention includes an aquatic feeder 10. The aquatic feeder 10 includes a first portion 18 connected to a second portion 12. The first portion 18 is made of a material floatable in water. The second portion 12 includes a sidewall defining an internal cavity. At least one aperture 14 is formed through the sidewall. A divider 17 is disposed in between the first portion 18 and the second portion 12 and acts as a cap for the internal cavity of the second portion 12. The internal cavity is configured to retain an aquatic animal food 28. The at least one aperture 14 is configured to allow the aquatic animal food 28 to be releasable when the at least one aperture is submerged in water 30. The aperture 14 is big enough to allow food 28 to flow through but small enough to prevent all of the food 28 from falling out at once.

The first portion 18 and the second portion 12 together may form a sphere. However, the feeder 10 of the present invention may be any shape that that allows the feeder 10 to float in water while being partially submerged exposing the apertures 14 for delivering food 28.

The first portion 18 and the second portion 12 are releasably connected together. The first portion 18 is a first half of the sphere and the second portion 12 is a second half of the sphere. In such embodiments, the first portion 18 includes a clip 22 protruding from a lower rim of the first portion 18 and the second portion 12 includes a clip slot 16 formed along an inner surface of an upper rim of the second portion 12. The clip 22 releasably connects to the clip slot 16.

In certain embodiments, the first portion 18 includes a first portion sidewall and the divider 17. The first portion sidewall and the divider 17 define an airtight internal compartment 24. A gas, such as air or a gas lighter than air, is disposed within the airtight internal compartment 24. Alternatively, the first portion 18 may be made of a floatable foam material.

A surface of the divider 17 facing the second portion may define a concave dome shape. Therefore, a user may pour food 28 into the concave dome shape of the first portion 18 and then connect the first portion 18 to the second portion 12.

In certain embodiments, the first portion 18 may further include a plurality of finger indents 20 formed on an outer surface of the first portion sidewall adjacent to the lower rim. This allows a user to easily grasp the first portion 18 and connect the first portion 18 to the second portion 12.

In certain embodiments, the at least one aperture of the second portion 12 may include a plurality of apertures 14 evenly spaced apart and radially disposed in between a bottom point or a central point of the dome shape of the second portion 12 and the upper rim of the second portion 12, i.e., a middle area of the second portion. The additional apertures 14 allow more food 28 to escape the feeder 10. For example, the present invention may include three apertures 14. The apertures 14 may be semi-circular shape having a flat bottom edge and a rounded top edge. The rounded top edge may be facing towards the upper rim. The shape and the location of the apertures 14 prevents food from escaping the feeder 10 until the feeder 10 is pushed at an angle and water runs through the apertures 14.

A method of feeding aquatic animals may include the following. Provide the feeder 10 described above. Separate the first portion 18 from the second portion 12 so that the internal cavity is exposed. Insert the aquatic animal food 28 within the internal cavity of the second portion 12. Releasably connect the first portion 18 to the second portion 12. Place the aquatic feeder 10 on top of water 30 within a water tank. The aquatic feeder 10 floats in the water 20. Fish 26 or other aquatic animals may manipulate the aquatic feeder 10 so that the apertures 14 submerge into the water 20. The aquatic animal food 28 escapes the internal cavity through the apertures 14 when the apertures 14 are submerged in water 30 and the fish 26 or other aquatic animals may eat the aquatic animal food 28.

It should be understood, of course, that the foregoing relates to exemplary embodiments of the invention and that modifications may be made without departing from the spirit and scope of the invention as set forth in the following claims.

What is claimed is:

1. An aquatic feeder comprising:
a first portion comprising a material floatable in water;
a second portion connected to the first portion, the second portion comprising a second portion sidewall defining an internal cavity and at least one aperture formed through the second portion sidewall; and
a divider forming a cap for the internal cavity, wherein
the internal cavity is configured to retain an aquatic animal food; and
the at least one aperture is configured to allow the aquatic animal food to be releasable when the at least one aperture is submerged in water.

2. The aquatic feeder of claim 1, wherein the first portion comprises a first portion sidewall and the divider, wherein the first portion sidewall and the divider define an air tight internal compartment, wherein a gas is disposed within the air tight internal compartment.

3. The aquatic feeder of claim 2, wherein a surface of the divider facing the second portion defines a concave dome shape.

4. The aquatic feeder of claim 1, wherein the first portion and the second portion together form a sphere.

5. The aquatic feeder of claim 4, wherein the first portion and the second portion are releasably connected together, wherein the first portion is a first half of the sphere and the second portion is a second half of the sphere.

6. The aquatic feeder of claim 5, wherein the first portion comprises a clip protruding from a lower rim of the first portion and the second portion comprises a clip slot formed along an inner surface of an upper rim of the second portion, wherein the clip releasably connects to the clip slot.

7. The aquatic feeder of claim 6, wherein the first portion further comprises a plurality of finger indents formed on an outer surface of the first portion sidewall adjacent to the lower rim.

8. The aquatic feeder of claim 1, wherein the at least one aperture comprises a plurality of apertures each comprising a semi-circular shape.

9. A method of feeding aquatic animals comprising:
providing an aquatic feeder comprising:
a first portion comprising a material floatable in water;
a second portion connected to the first portion, the second portion comprising a second portion sidewall defining an internal cavity and at least one aperture formed through the second portion sidewall; and
a divider forming a cap for the internal cavity;
inserting an aquatic animal food within the internal cavity of the second portion; and
placing the aquatic feeder on water within a water tank, wherein
the aquatic feeder floats in the water, and
the aquatic animal food escapes the internal cavity through the at least one aperture when the at least one aperture is submerged in water.

10. The method of claim 9, further comprising the steps of:
separating the first portion from the second portion so that the internal cavity is exposed;
inserting the aquatic animal food within the internal cavity of the second portion; and
releasably connecting the first portion to the second portion.
